(19) United States
(12) Patent Application Publication
(10) Pub. No.: US 2003/0174366 A1
(43) Pub. Date: Sep. 18, 2003

(54) Transfer destination forwarding method in facsimile communication and facsimile apparatus

(76) Inventor: Shinichi Momonami, Nara-shi (JP)

Correspondence Address: BIRCH STEWART KOLASCH & BIRCH, PO BOX 747, FALLS CHURCH, VA, 22040-0747, US

(21) Appl. No.: 10/379,601

(22) Filed: Mar. 6, 2003

(30) Foreign Application Priority Data
Mar. 6, 2002 (JP) P2002-60296

(51) Int. Cl. G06F 15/00; B41J 1/00; H04N 1/00

(52) U.S. Cl. 358/407; 358/1.15

(57) ABSTRACT

It is an object of the invention to enable a facsimile apparatus not having a relay function to normally receive facsimile communication and a facsimile apparatus having the relay function to transfer facsimile communication to other facsimile apparatuses as relay destinations. Information succeeding an RTC signal transmitted after transmission of image data of one page by a facsimile communication procedure in accordance with an ITU recommendation is handled as a transfer address designating a relay destination. An E-mail address can be designated as the transfer address besides a telephone address. When facsimile communication is transferred to the E-mail address, the image data received by facsimile communication is converted to a data format suitable for a protocol of an information communication network and is then transferred.

### BACKGROUND OF THE INVENTION

1. Field of the Invention

This invention relates to a transfer destination forwarding method in facsimile communication for forwarding an address of a relay destination with an image and relaying facsimile communication, and to a facsimile apparatus.

2. Description of the Related Art

Facsimile communication has been made in the past in accordance with the standard stipulated by International Telecommunication Union abbreviated as ITU. Since the ITU does not stipulate a relaying method in facsimile communication, various proposals have been made. A relaying procedure in facsimile communication includes the steps of forwarding once an image to be transferred to a facsimile apparatus and transferring the image from the facsimile apparatus to a destination. Such a relay method is a method that can drastically reduce a communication cost and provides great effects particularly when the number of destinations at remote places is great because the method once forwards the image to a facsimile apparatus at a relay point on which the destinations concentrate, and then forwards the image to a large number of destinations. When the image is forwarded through an information communication network such as the Internet, the image can be forwarded to the Internet from a facsimile apparatus not connected to the Internet through a relay apparatus capable of communication with the Internet. When the image can be forwarded through the Internet, a great effect can be acquired in the reduction of the communication cost.

The known technology described in Japanese Unexamined Patent Publication JP-A 9-284447 (1997), for example, adds transfer data as a telephone number of a transfer destination of image data to the image data read by image reading means, creates code data by integrating the image data with the transfer data and transmits the code data through a public-switched telephone network. When the code data containing the transfer data is received, the code data is transmitted to a designated transfer destination on the basis of the transfer data.

The known technology, a FAX-electronic mail gateway apparatus described in Japanese Unexamined Patent Publication JP-A 11-146007 (1999) includes a storage portion for storing a table having an electronic mail address of a transfer destination corresponding to an originating party, detects originating party data contained in header information of a FAX document forwarded from a transmission facsimile apparatus, retrieves the transfer destination electronic mail address corresponding to the originating party data so detected from the table, and transfers the electronic mail with an attached file of the image data received by FAX to a personal computer of the transfer destination mail address.

Further, the known technology described in Japanese Unexamined Patent Publication JP-A 10-229464 (1998) codes return destination information or transfer destination information and synthesizes document image data to be transmitted with a code image to create a transmission image. The known technology described in Japanese Unexamined Patent Publication JP-A 11-252301 (1999) provides an Internet FAX apparatus that establishes connection with a LAN and can transmit image data by switching a G3FAX mode to an Internet FAX mode not requiring communication expenses. The known technology described in Japanese Unexamined Patent Publication JP-A 2001-169121 (2001) adds transfer data to coded image data after coding of the image data and creates coded data. A command flag representing the existence of command data (transfer command), command data instructing a transfer operation to a facsimile apparatus receiving the coded data (transfer command) and status data representing the transfer destination number (transfer destination number data) are added before an EOL (End Of Line) existing at a leading part of one page of image data.

The known technologies described above employ the method that adds the facsimile transfer destination address or the E-mail address to the image transferred by facsimile communication, the method that inserts the transfer data before the first EOL in the image, the method that superposes the data of the transfer destination with the image, and so forth. However, no technology is known that inserts the transfer destination address after an RTC.

Incidentally, Japanese Unexamined Patent Publication JP-A 3-235580 (1991) describes the known technology that uses a control signal representing the end of the image information as a delimiter between the image information and the addition information, transmits and receives the addition information of a transmission limit in the same way as the image information by use of transmission/reception control of the image information and eliminates transmission/reception of a complicated command response at the start of transmission.

According to the known technology described in Japanese Unexamined Patent Publication JP-A 4-82475 (1992), a facsimile apparatus generates a parity bit signal in a sub-scanning direction and adds the parity bit signal after the RTC signal of the image signal. A reception facsimile apparatus detects an error of each line at the time of decoding of the facsimile signal, and restores a line having the error by the parity bit signal when the line having the error is one line.

To conduct the relay operation in facsimile communication, a transfer address as a relay destination must be forwarded from the transmission facsimile apparatus to the relay facsimile apparatus. The relay function in facsimile communication generally uses an NSS (Non-Standard function) deviating from the ITU standard to transmit the relay destination address. Therefore, models that can be used for the originating party and the relay apparatus are limited. Generally, the facsimile apparatuses are limited to the models that are produced by the same manufacturer and have the same function. Moreover, in the event that a facsimile signal containing the transfer address as a part of the image signal is forwarded to a facsimile apparatus not having the same function, the facsimile signal cannot be received as an image by ordinary facsimile communication.

### SUMMARY OF THE INVENTION

It is an object of the invention to provide a method of forwarding of a transfer destination in facsimile communication that enables a facsimile apparatus having no relay function to normally receive facsimile communication and a facsimile apparatus having the relay function to transfer facsimile communication to other facsimile apparatuses as relay destinations, and a facsimile apparatus.

The invention provides a transfer destination forwarding method in facsimile communication for forwarding relay destination information about a transfer address of a relay destination with an image to be transferred to a facsimile apparatus having a relay function in order to forward the image to the facsimile apparatus and transfer the image from the the facsimile apparatus, comprising: conducting facsimile communication to the facsimile apparatus having the relay function in accordance with the ITU recommendation; and forwarding the relay destination information by the same modulation method as that of the image signal after an RTC signal stipulated as an end signal of an image signal by the ITU recommendation.

According to the invention, in order to forwarding the image to the facsimile apparatus having the relay function and transfer the image from the facsimile apparatus, the relay destination information about the transfer address of the relay destination is forwarded with the image by the same modulation method as that of the image signal after the RTC signal stipulated as the end signal of the image signal by the ITU recommendation. When the relay destination information is forwarded in the known relay method, it has been necessary to conduct facsimile communication by the NSS deviating from the ITU standard to a relay facsimile apparatus capable of interpreting the same non-standard function as that of the transmission facsimile apparatus. In the invention, on the other hand, facsimile communication to a facsimile apparatus is conducted in accordance with the ITU recommendation. Therefore, even when a facsimile apparatus not having the relay function receives the image, it can normally receive the image. The relay destination information about the transfer address of the relay destination is forwarded by the same modulation method as that of the image signal after the RTC signal. Therefore, a facsimile apparatus having a matching relay function can easily recognize the relay destination information and can relay facsimile communication. Even when a reception facsimile apparatus cannot interpret the relay destination information, the loss of the information can be prevented. For example, even when the model of the relay facsimile apparatus cannot interpret the relay destination information after the RTC signal, it is possible to forward the image received by the relay facsimile apparatus to an address existing inside the image through a manual operation or as E-mail. Transmission of the information becomes thus possible.

In the invention it is preferable that the relay destination information contains a plurality of transfer addresses.

According to the invention, because the relay destination information contains a plurality of transfer addresses, the image can be transferred to a plurality of relay destinations by one facsimile communication to the facsimile apparatus having the relay function, and the communication cost can be drastically reduced.

In the invention it is preferable that the relay destination information contains the address of the electronic mail.

According to the invention, when the electronic mail address is contained as the relay destination information, the facsimile apparatus having the relay function transfers the image as the electronic mail to the relay destination. In consequence, facsimile communication can be transmitted through the information communication network from the facsimile apparatus not having the facsimile communication function through the information communication network such as the Internet.

According to the invention, facsimile communication reaching as the electronic mail the relay destination can be transmitted from the facsimile apparatus not having the facsimile communication function through the information communication network such as the Internet.

In the invention it is preferable that when images of a plurality of pages are transferred to the same transfer destination by facsimile communication, the images of a plurality of pages are grouped into a group and the relay destination information is forwarded after the RTC signal of the last page of the group.

According to the invention, since the relay destination information exists after the RTC signal of the image of the last page of the images of a plurality of pages, the relay destination can be known only after all the images are received. Therefore, when reception of all the images is incomplete, the relay destination cannot be known. It is thus possible to prevent the incomplete images from being transferred.

According to the invention, further, the images can be transferred after all of them are received, and the incomplete images can be prevented from being transferred.

In the invention it is preferable that a conversion table between the relay destination information and the transfer address of the relay destination is provided to the facsimile apparatus having the relay function, and the facsimile apparatus having the relay function can convert the relay destination information forwarded with the facsimile communication to be relayed to the transfer address by the conversion table.

According to the invention, since the conversion table between the relay destination information and the transfer address of the relay destination is provided to the facsimile apparatus having the relay function, the invention can designate the group name as the relay destination and can convert it to a plurality of transfer addresses, and can conduct the relay operation by converting the relay destination information designating the original transfer destination to the transfer address after a change of the transfer address even when such a change occurs.

The invention further provides a facsimile apparatus having functions of forwarding an image to a facsimile apparatus having a relay function and transferring the image from the facsimile apparatus, comprising: relay destination inputting means for inputting relay destination information about a transfer address of a relay destination; and facsimile communication means for conducting facsimile communication to the facsimile apparatus having the relay function in accordance with the ITU recommendation and executing control in such a fashion that the relay destination information inputted to the relay destination inputting means by the same modulation method as that of an image signal can be forwarded after an RTC signal stipulated as an end signal of the image signal by the ITU recommendation.

According to the invention, the facsimile apparatus having functions of forwarding the image to the facsimile apparatus having the relay function and transferring the image from the facsimile apparatus includes the relay destination inputting means and the facsimile communication means. The relay destination inputting means inputs the relay destination information about the transfer address of the relay destination. The facsimile communication means conducts facsimile communication to the facsimile apparatus having the relay function in accordance with the ITU recommendation and executes control in such a fashion that the relay destination information inputted to the relay destination inputting means by the same modulation method as that of the image signal can be forwarded after the RTC signal stipulated as the end signal of the image signal by the ITU recommendation. When the relay destination information is inputted to the relay destination inputting means, the facsimile communication means adds the relay destination information after the RTC signal after the end of the image signal and conducts facsimile communication. Therefore, the relay function of the facsimile apparatus having the relay function can be effectively utilized.

The invention further provides a facsimile apparatus having a relay function of transferring an image received through facsimile communication to other facsimile apparatus, comprising: facsimile communication means for conducting facsimile communication in accordance with the ITU recommendation; address recognition means for recognizing a transfer address based on relay destination information when the relay destination information is added by the same modulation method as that of an image signal after an RTC signal stipulated as an end signal of the image signal by the ITU recommendation in facsimile communication received by the facsimile communication means; image storage means for storing an image represented by the image signal of facsimile communication received by the facsimile communication means; and transfer control means for controlling the facsimile communication means so that the image stored in the image storage means can be transferred by facsimile communication to the transfer address recognized by the address recognition means.

According to the invention, the facsimile apparatus having the relay function of transferring the image received through facsimile communication, to other facsimile apparatus includes the facsimile communication means, the address recognition means, the image storage means and the transfer control means. The address recognition means recognizes the transfer address based on relay destination information when the relay destination information is added by the same modulation method as that of the image signal after the RTC signal stipulated as the end signal of the image signal by the ITU recommendation in facsimile communication received by the facsimile communication means in accordance with the ITU recommendation. The image storage means stores the image represented by the image signal of facsimile communication received by the facsimile communication means. The transfer control means controls the facsimile communication means so that the image stored in the image storage means can be transferred by facsimile communication to the transfer address recognized based on relay destination information by the address recognition means.

In the invention it is preferable that the transfer control means controls the facsimile communication means so that the images stored in the image storage means can be transferred to a plurality of relay destinations when the address recognition means recognizes these relay destinations as the transfer address.

According to the invention, the facsimile apparatus having the relay function can transfer the images to a plurality of relay destinations. Therefore, the number of cases becomes greater where the communication cost can be reduced much more than when facsimile communication is directly made from the originating party to the relay destinations.

In the invention it is preferable that the facsimile communication means can conduct facsimile communication through a public-switched telephone network and through an information communication network, and the transfer control means controls the facsimile communication means so that facsimile communication through the public-switched telephone network and facsimile communication through the information communication network can be switched on the basis of the format of the transfer address recognized by the address recognition means.

According to the invention, facsimile communication can be conducted on the basis of the format of the transfer address recognized by the address recognition means through the public-switched telephone network when the telephone number is contained in the relay destination information and through the information communication network when the electronic mail address is contained in the relay destination information, for example.

According to the invention, facsimile communication can be conducted by dividedly using the public-switched telephone network and the information communication network on the basis of the format of the transfer address contained in the relay destination information.

In the invention it is preferable that the transfer control means groups images of a plurality of pages into a group and controls the facsimile communication means in such a fashion as to transfer the images to the transfer address by facsimile communication when the transfer address recognized by the address recognition means is added after the last image of the images of a plurality of pages.

According to the invention, the relay destination information is added after the RTC signal of the last page when the images of a plurality of pages are collectively forwarded. Therefore, image transfer can be made only when all the images of a plurality of pages can be normally received.

In the invention it is preferable that the address recognition means includes a conversion table between the relay destination information and the transfer address of the relay destination, and converts the relay destination information added to the facsimile communication received by the facsimile communication means to the transfer address by using the conversion table.

According to the invention, the relay destination information is converted to the transfer address by using the conversion table. It is therefore possible to convert a predetermined group name to the transfer addresses of a plurality of relay destinations as the relay destination information, and to convert obsolete relay destination information to the latest transfer addresses and to conduct the relay operation.

In the invention it is preferable that the transfer control means controls the facsimile communication means so that, when the relay destination information is added to facsimile communication received by the facsimile communication means, the facsimile communication means conducts the transfer operation only when a predetermined condition is satisfied.

According to the invention, the transfer control means controls the facsimile communication means so that when the relay destination information is added to facsimile communication received by the facsimile communication means, the facsimile communication means conducts the transfer operation only when a predetermined condition is satisfied. Therefore, the relay operation can be made by selecting the object to which facsimile communication is relayed, such as inside the same company.

The invention further provides a program for causing a computer to operate as any of the facsimile apparatuses described above.

According to the invention, the computer is furnished with the facsimile communication function, and the image of facsimile communication received from the facsimile apparatus of the originating party can be transferred on the basis of the relay destination information added after the RTC signal in facsimile communication.

The invention further provides a computer-readable storage medium that records a program for causing a computer to operate as any of the facsimile apparatuses described above.

According to the invention, the computer is caused to read the program and to operate as the facsimile apparatus, and the images of facsimile communication received from the facsimile apparatus of the originating party can be transferred on the basis of the relay destination information added after the RTC signal in facsimile communication.

### BRIEF DESCRIPTION OF THE DRAWINGS

Other and further objects, features, and advantages of the invention will be more explicit from the following detailed description taken with reference to the drawings wherein:

FIG. 1 is a block diagram showing a system construction for executing a transfer destination forwarding method in facsimile communication according to an embodiment of the invention;

FIG. 2 is a block diagram showing an example of a method of connecting a facsimile apparatus to the Internet shown in FIG. 1;

FIG. 3 is a block diagram showing a schematic electric construction of an Internet facsimile apparatus that can be used as a relay facsimile, a relay Internet facsimile shown in FIG. 1, or as a facsimile shown in FIG. 2;

FIG. 4 shows a transfer address buried in a facsimile communication image in the embodiment of the invention;

FIG. 5 is a flowchart showing a procedure of a relay operation in the embodiment shown in FIG. 1; and

FIG. 6 is a flowchart showing a procedure of a relay operation in another embodiment of the invention.

### DETAILED DESCRIPTION OF THE PREFERRED EMBODIMENTS

Now referring to the drawings, preferred embodiments of the invention are described below.

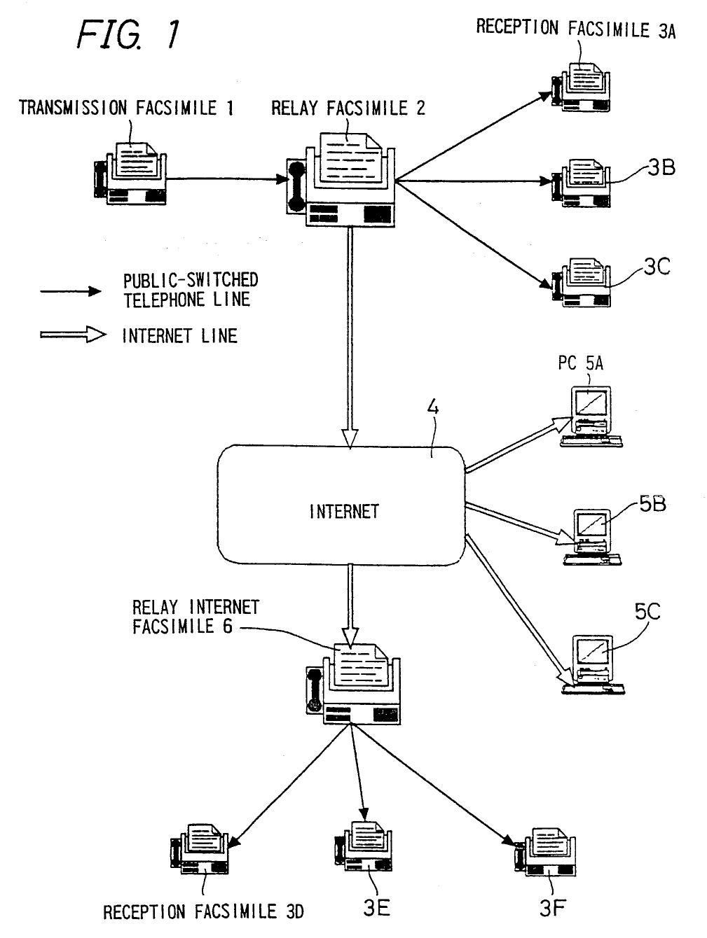

FIG. 1 shows a system construction for executing a transfer destination forwarding method in facsimile communication according to an embodiment of the invention. An image to be transmitted is read by a transmission facsimile 1 as an originating party. After relay destination information necessary for transfer is added, the image is forwarded to a relay facsimile 2. The relay facsimile 2 transfers the image it receives to one or a plurality of reception facsimiles 3A, 3B and 3C on the basis of the relay destination information from the transmission facsimile 1. This is an ordinary relay multi-address operation. The relay facsimile 2 according to this embodiment has a function of an Internet facsimile, too.

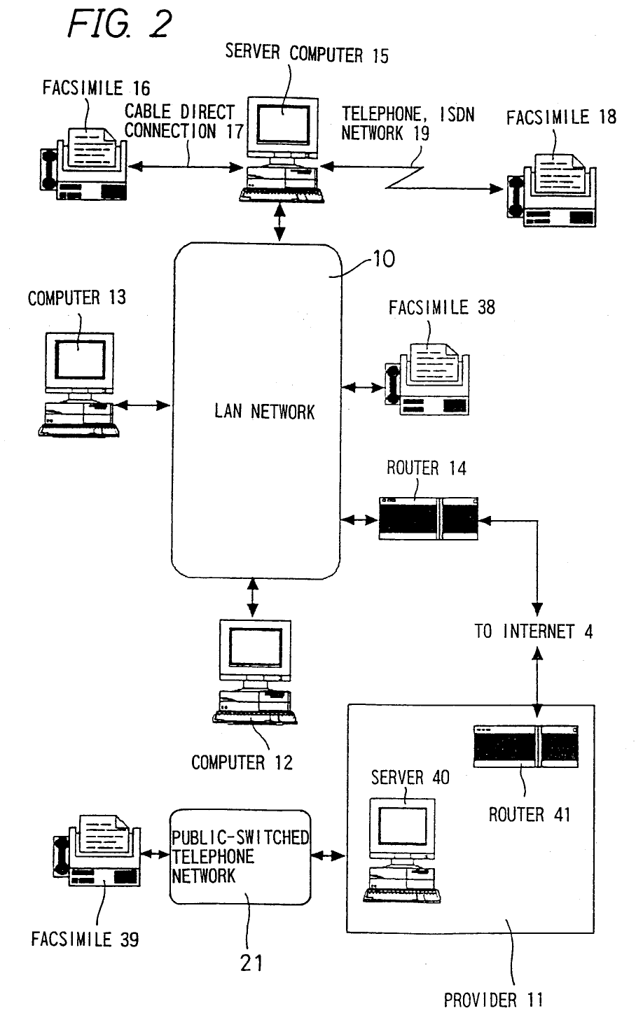

When the address added as the relay destination information from the transmission facsimile 1 indicates a terminal inside an Internet 4 such as one or a plurality of personal computers (hereinafter called “PC”) 5A, 5B and 5C, the image information received is changed to a data structure suitable for the Internet 4 and the data is transmitted to the Internet 4 because the relay facsimile 2 has the function of the Internet facsimile apparatus capable of data transmission to the Internet 4. Further, it is possible to forward the image to a relay Internet facsimile 6 connected with the Internet 4 through the Internet 4 and to execute relay multi-address transmission to one or a plurality of reception facsimiles 3D, 3E and 3F by this relay Internet facsimile 6. When the relay Internet facsimile 6 exists in this case at a remote place such as in a foreign country, communication expenses can be drastically reduced as the Internet 4 bypasses an international telephone line. To connect the terminals to the Internet 4, communication is conducted in most cases through a LAN (Local Area Network) or through a provider. FIG. 2 shows the detail that is not shown in FIG. 1.

FIG. 2 shows an example of a method of connecting the facsimile apparatus to the Internet 4 shown in FIG. 1. The drawing shows two connection methods. One uses a company LAN widely used for business purposes and establishes connection from an LAN network 10 to the Internet 4. The other is a method ordinarily used by individual users for establishes connection to the Internet 4 through an Internet service provider 11 called “ISP” or “provider” for short. In the case of the LAN, computers 12 and 13 as terminal apparatuses of the clients are connected to the LAN network 10 and to the Internet 4 through a router 14 from the LAN network 10. At the same time, a server computer 15 is connected to the LAN network 10, and temporarily stores communication data to the clients the server computer 15 manages, such as text data, the facsimile image or sound that is received. This circuit construction represents an example of the construction for connecting the facsimile apparatus to the Internet 4, and connection of the facsimile apparatus to the data line as the subject matter of the invention is not limited to the example shown in the drawing.

A facsimile 16 shown in FIG. 2 is directly connected to the server computer 15 through a cable 17, and the drawing represents an example of the connection method of the facsimile apparatus as the subject matter of the invention. When the facsimile 16 is used as a printer of the server computer 15, however, data is directly transferred from the server computer 15 to the facsimile 16 when the server computer 15 receives an E-mail and printing is conducted. On the contrary, the facsimile 16 directly transfers the image as the object of facsimile communication to the server computer 15.

A facsimile 18 shown in FIG. 2 represents an example where it is connected to the server computer 15 through a public-switched telephone network or an ISDN network 19. The facsimile 18 must be able to interpret a protocol such as TCP/IP and to generate signals to make a call with the server computer 15 through the network.

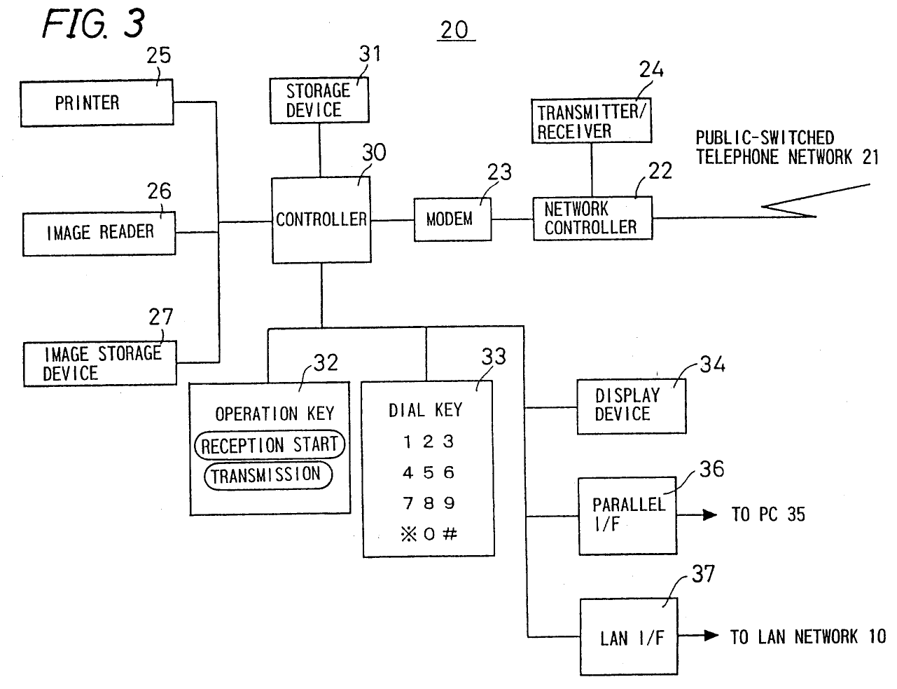

FIG. 3 shows a schematic electric construction of an Internet facsimile apparatus 20 that can be used as the relay facsimile 2 and the relay Internet facsimile 6 shown in FIG. 1 or as the facsimile 18 shown in FIG. 2. The Internet facsimile apparatus 20 is connected to the public-switched telephone network 21 through a network controller 22. The network controller 22 monitors the state of the public-switched telephone network 21 and switches the connection destination to the public-switched telephone network 21 between the side of a modem 23 and the side of a transmitter/receiver 24. The modem 23 executes modulation for converting digital signals of the image to analog signals suitable for the public-switched telephone network 21 and demodulation for converting the analog signals received from the public-switched telephone network 21 to the digital signals for printing. A printer 25 is a unit that executes printing of the image that is received or read, and uses in most cases a thermal method, an electrophotographic method or an ink jet method. An image reader 26 is a reader for reading an original for transmission or for copying, and uses a reduced scale read system using a combination of, lenses with a CCD line sensor and a contact sensor system using a rod lens array. An image storage device 27 which is an image storage means is a unit that stores a read image or a received image. When this unit is provided, it becomes possible to execute various complicated functions such as transfer of the received image, multi-address transmission, a substitutional reception at the time of out of paper, memory transmission, and so forth. The relay facsimile 2 shown in FIG. 1 stores the image it has once received into this image storage device 27 and then transfers it to the reception facsimiles 3A to 3F.

A controller 30 shown in FIG. 3 decides the operations of the apparatus as a whole on the basis of input information from an operation key 32 and a dial key 33, information representing the state from each unit of the Internet facsimile apparatus 20 and the signals from the public-switched telephone network 21 in cooperation with a program stored in a storage device 31, gives instruction to the overall apparatus and further gives display instruction to a display apparatus 34. The controller 30 compresses the image to shorten a transmission time of the image information and expands the compressed image signal to the original pixel string information. The operation key 32 and the dial key 33 are the units used by the user for inputting information and instruction to the apparatus. The display device 34 is the unit for the Internet facsimile apparatus 20 to display information for the user and to give guidance to the user. The network controller 22, the modem 23 and the controller 30 function as facsimile communication means, and the controller 30 also functions as address recognition means and transfer control means.

When the relay facsimile 2 is used as the originating party and when the user inputs a telephone number as a transfer address, the user can directly input the telephone number through the dial key 33. When the user inputs an E-mail address, the user input it by allocating alphabets to the dial key 33. In this embodiment, the dial key 33 is used as relay destination inputting means, however, substitute for the dial key 33, it is also possible to transfer the data of the transfer address from other PC to let the image reader 26 read a form describing the transfer address and to input the address through character recognition.

FIG. 3 shows three kinds of interfaces (hereinafter called “I/F” for short) that enable the Internet facsimile apparatus 20 and the Internet to communicate with each other. That is, they are a speech path with the public-switched telephone network 21, a parallel I/F 36 as an interface to the PC 35 and a LAN I/F 37 as an interface to the LAN network 10. Though the drawing shows the parallel I/F 36 as the interface to the PC 35, the interface is not always limited to the parallel interface.

FIG. 3 shows the Internet facsimile apparatus 20and three kinds of interfaces outside the apparatus. Generally, however, ordinary facsimile transmission/reception by the interface with the public-switched telephone network 21 and communication with the Internet 4 through any one of the other interfaces are conducted. Alternatively, ordinary direct facsimile transmission/reception through the public-switched telephone network 21 and communication with the server computer 15 on the LAN network 10 or on the Internet server 4 are conducted. In other words, there is the case where all the facsimile communications are made through the public-switched telephone network 21. Here, the drawing shows three kinds of interfaces as useful connection methods with the Internet 4 and all these three kinds of interfaces need not always be provided. When the Internet facsimile apparatus 20 is connected to the PC 35, they are directly connected through a cable equivalent to the cable 17 shown in FIG. 2 as the parallel I/F 36.

Call is connected to the telephone network 31 (including an ISDN network) through the network controller 32 shown in FIG. 3. A facsimile 39 shown in FIG. 2 represents an example where it is connected through the LAN network 10. In this case, the facsimile apparatus 39 is connected to the LAN network 10 through the LAN interface 37 shown in FIG. 3. The invention can be accomplished by use of any of these connection methods.

Connection of the facsimile apparatus 39 shown in FIG. 2 with the Internet 4 uses a connection method that an individual generally uses for connecting the Internet 4. The user makes contract with the Internet service provider 11 as the Internet connection company and connects to the Internet service provider 11 through the public-switched telephone network 21 such as the telephone network or the ISDN network. The Internet service provider 11 stores transmission/reception information of the client such as the facsimile apparatus 39 into a server 40 used for management, connects the facsimile apparatus 39 to the Internet 4 through a router 41 and transmits the information to the Internet 4 or receives the information from the Internet 4.

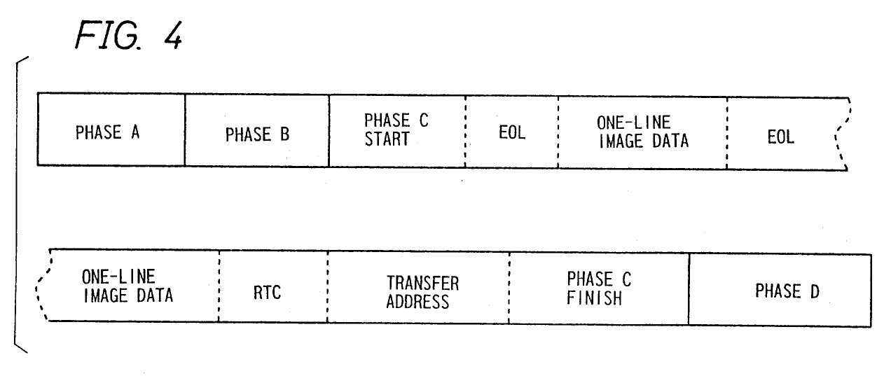

FIG. 4 shows a transfer address buried into the facsimile communication image in this embodiment. In facsimile communication, through a phase A that is a procedure till call is set and through a phase B as a hand-shaking procedure, a phase C as transmission of the image is started. In this phase C, data of one line in a main scanning direction of the image and an EOL representing the end of the one line are alternately forwarded, and this procedure is repeated until the images of one page are finished. The EOL is represented by a 12-bit code string “000000000001”. When the images of one page are finished, an RTC signal in which six EOL signals continue represents the finish of the images. It is a feature of the invention that a transfer address is added after this RTC signal. Since the transfer address is added by the same modulation method as that of the image signals, an ordinary facsimile apparatus can receive the transfer address. It is based on the premise, however, that when such a transfer address is added after the RTC signal, the facsimile apparatus should be able to interpret that the address represents the transfer address. A telephone number through the public-switched telephone network can designate the relay destination. Particularly, an E-mail address of an E-mail can be contained in this transfer address.

When the phase C is finished by forwarding the transfer address, the procedure proceeds to a hand-shaking procedure for disconnecting the call or to a phase D as a hand-shaking procedure to a next page. Here, when a plurality of pages are transferred, there is no particular limitation as to whether the transfer addresses are added to all the pages or to the last page. However, it is preferred to insert the transfer address to the last part of the last page so that the transfer address can be transferred after all the pages are forwarded but the image that is interrupted at an intermediate part of the procedure is not transferred.

When relay multi-address communication is executed in customary facsimile communication, an ordinary transmission method is as follows. The addresses are written to a SUB signal in the hand-shaking procedure (phase B), the telephone numbers of the multi-address are transferred to the relay destination, the relay facsimile apparatus serially transmits the content to the telephone numbers and serially distributes it to a plurality of destinations. However, such a relay multi-address transmission function is a non-standard function (NSS) deviating from the ITU standard. Therefore, models of the facsimile apparatus as the originating party and the relay facsimile apparatus are limited, generally to those models that are produced by the same manufacturer and have the same function.

In the invention, the transfer address is added after the RTC signal. Therefore, even when the reception facsimile apparatus cannot interpret the transfer address, it can normally receive the image with only the exception that the transfer address is ignored. In the case where the relay is requested for the telephone number that is expected to have the facsimile apparatus capable of interpreting the transfer address of the invention and a facsimile apparatus of a model not capable of interpreting the transfer address is connected for some reason or other, it is possible to judge the transfer address from the content of description of the destination represented by the image received, and to transmit the information either manually or as an E-mail. It is thus possible to prevent the loss of the information.

Further, it is possible to add an attached address so that a plurality of images can be transferred from one relay facsimile apparatus to different relay destinations. In other words, the transfer address of a certain relay destination is added in succession to the RTC signal after a page to be transferred to the relay destination, and the transfer address of another relay destination is added in succession to the RTC signal after a page to be transferred to this relay destination. In this case, as to a page to which the transfer address is not added after the RTC signal so that a plurality of pages can be transferred as a group to a certain relay destination, the image may well be forwarded to the same relay destination as the page that is forwarded after the page not having the transfer address and to which the transfer address is added.

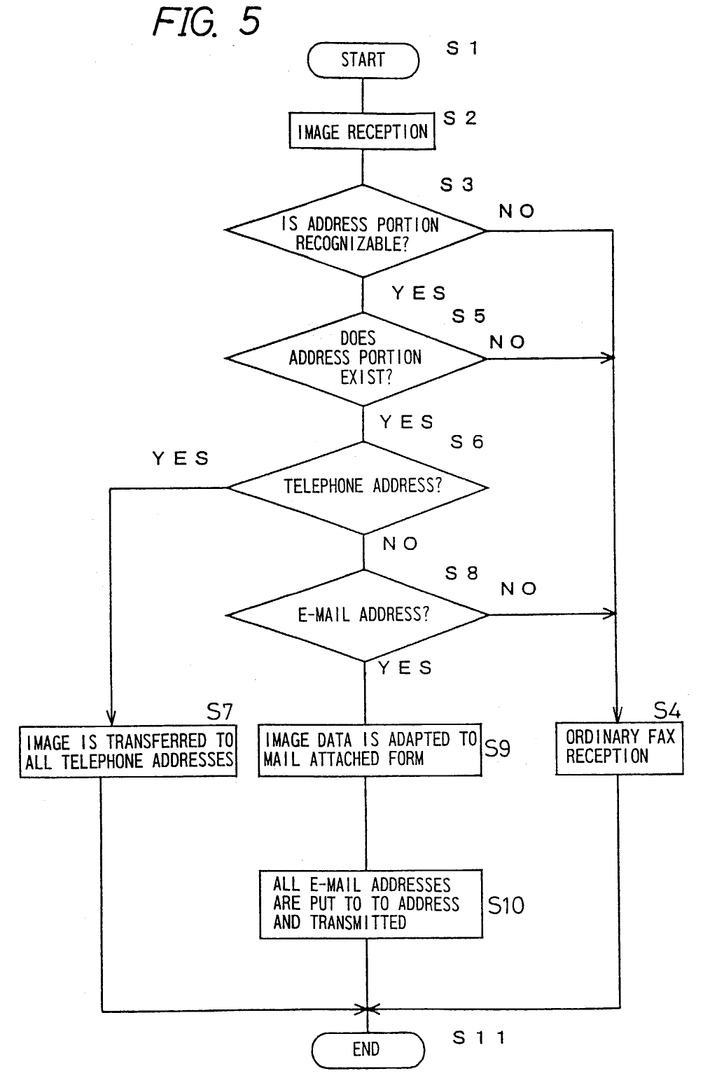

FIG. 5 shows a transfer processing procedure in the relay facsimile 2 shown in FIG. 1. The procedure from step S1 is started with the start of the phase C shown in FIG. 4. At step S2, the reception of image is conducted through facsimile communication. At step S3, whether or not an address portion as the transfer address added after the RTC signal can be recognized is judged. When the relay facsimile apparatus is the one that cannot interpret the transfer address of the invention, this judgment is not made, and the situation is equivalent to the case where the address portion is judged as being irrecognizable. Therefore, a reception processing as ordinary facsimile communication is conducted at step S4. When the image received has the address of the transfer destination, this image can be transferred by the manual operation to the delay destination.

When a facsimile apparatus capable of interpreting the transfer address of the invention is used as the relay facsimile 2, the judgment result at step S3 proves recognizable and the flow proceeds to step S5. At step S5, whether or not the transfer address is added as the address portion of the received image after the RTC signal. When the address portion does not exist, the ordinary facsimile reception operation from step S4 is started.

When it is judged that the transfer address is added at step S5, whether or not the telephone address such as the telephone number and the FAX number is added as the transfer address is judged at step S6. When it is is judged that the telephone address is added, at step S7, the image is transferred to the relay destination corresponding to each telephone address through the public-switched telephone network. When it is judged that the address of the relay destination is not the telephone address at step S6, whether or not the transfer address is a URL (Uniform Resource Locator) on the Internet 4, for example, the E-mail address is judged in step S8. When the transfer address is not the E-mail address, the ordinary facsimile reception processing is executed at step S4. When it is judged that the E-mail address is added at step S8, the image data to be received through the facsimile communication is so changed as to match with the mail attached form of the Internet 4 at step S9. Next, at step S10, all the E-mail addresses are set to a destination “TO” by use of software for handling the E-mail, and the image is forwarded to each address as the transfer through the Internet 4. Both the telephone address and the E-mail address are contained in some cases. Therefore, step S7 and steps S9 and S10 are serially executed in parallel with one another. When facsimile reception at step S4 and facsimile transfer at step S7 or S10 are finished, the procedure is finished at step S11, too.

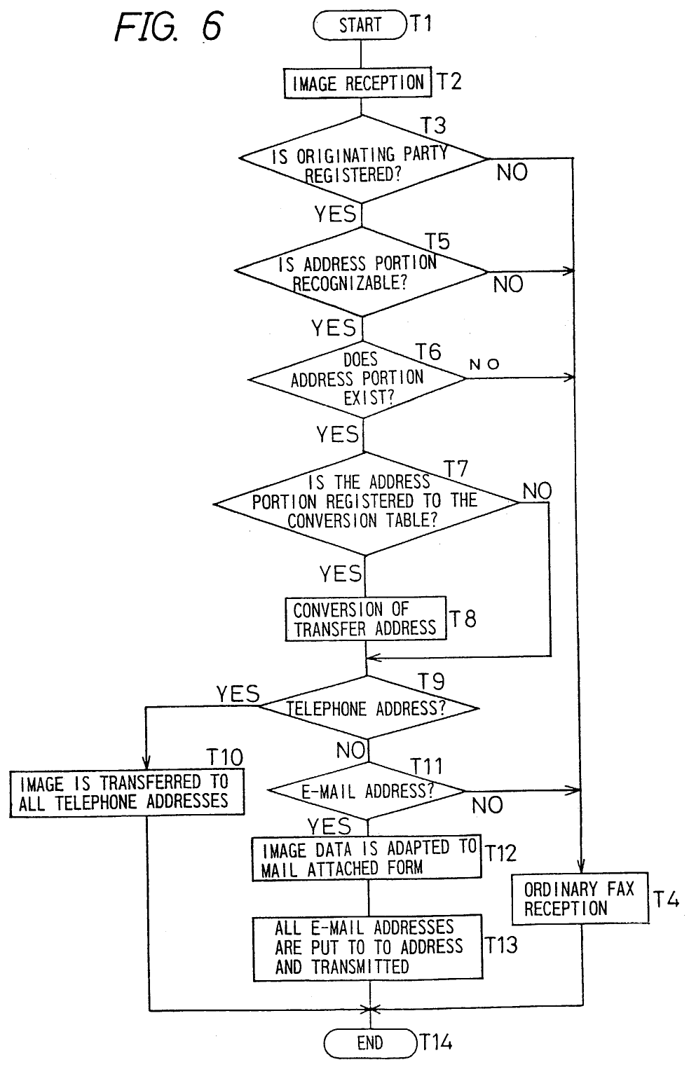

FIG. 6 shows a transfer processing procedure as another embodiment of the invention. This embodiment executes the transfer by using the construction of the relay facsimile 2 shown in FIG. 1, too. The procedure from step T1 is started simultaneously with the start of the phase C shown in FIG. 4. At step T2, the reception of image is conducted through facsimile communication. At step T3, the originating party is confirmed and whether or not relay is to be made is judged. The originating party can be confirmed on the basis of the telephone number. The originating party for executing the relay operation inside the same company or the like, is registered to the storage device 31 shown in FIG. 3 in advance. Whether or not the transfer is to be made can be judged on the basis of a password or the like, too. Each of steps T4 to T6 is equivalent to each of the steps S3 to S5 shown in FIG. 5.

In this embodiment, a conversion table of the transfer address is provided in the storage device 31 or the like shown in FIG. 3. The flow proceeds to step T7 when it is judged that the address portion as the relay destination information exists after the RTC signal at step T6. Whether or not the address portion is registered to the conversion table is judged at step T7. When the address portion is registered to the conversion table, the address portion is converted to a corresponding transfer address in accordance with the conversion table at step T8, and the flow proceeds to step T9. When it is judged that the address portion is not registered to the conversion table at step T7, the flow proceeds to step T9 without conducting conversion. Each of steps T9 to T14 is equivalent to each of the steps S6 to S11 in FIG. 5.

It is possible in this embodiment to conduct the transfer only when the condition that the originating party is in advance registered is satisfied without allowing the relay facsimile 2 to unconditionally conduct the transfer. Since the transfer address is converted on the basis of the conversion table, the transfer address can be converted to a new transfer address and can be then transferred if any change exists. When a group is designated as the relay destination information, the transfer address can be converted to a plurality of transfer addresses contained in the group.

The facsimile apparatus according to each embodiment of the invention can be accomplished by a program processing by adding a communication function to a general-purpose computer through the public-switched telephone network 21 such as the modem. The program can be stored in an ROM in advance. The program can be recorded to a storage medium provided to the computer such as a hard disk drive, or can be read from a detachable optical or magnetic recording medium to an RAM, and can be executed. The program can be down-loaded and executed through the information communication network such as the Internet 4. The image created by the facsimile apparatus as the originating party can be directly created from output data of a word processor representing the content of an original without reading the original.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A transfer destination forwarding method in facsimile communication for forwarding relay destination information about a transfer address of a relay destination with an image to be transferred to a facsimile apparatus having a relay function in order to forward the image to the facsimile apparatus and transfer the image from the facsimile apparatus, comprising:
conducting facsimile communication to the facsimile apparatus having the relay function in accordance with the ITU recommendation; and
forwarding the relay destination information by the same modulation method as that of the image signal after an RTC signal stipulated as an end signal of an image signal by the ITU recommendation.

2. The method of claim 1, wherein the relay destination information contains a plurality of transfer addresses.

3. The method of claim 1, wherein the relay destination information contains the address of the electronic mail.

4. The method of claim 1, wherein when images of a plurality of pages are transferred to the same transfer destination by facsimile communication, the images of a plurality of pages are grouped into a group and the relay destination information is forwarded after the RTC signal of the last page of the group.

5. The method of claim 1, wherein a conversion table between the relay destination information and the transfer address of the relay destination is provided to the facsimile apparatus having the relay function, and the facsimile apparatus having the relay function can convert the relay destination information forwarded with the facsimile communication to be relayed to the transfer address by the conversion table.

6. A facsimile apparatus having functions of forwarding an image to a facsimile apparatus having a relay function and transferring the image from the facsimile apparatus, comprising:
relay destination inputting means for inputting relay destination information about a transfer address of a relay destination; and
facsimile communication means for conducting facsimile communication to the facsimile apparatus having the relay function in accordance with the ITU recommendation and executing control in such a fashion that the relay destination information inputted to the relay destination inputting means by the same modulation method as that of an image signal can be forwarded after an RTC signal stipulated as an end signal of the image signal by the ITU recommendation.

7. A facsimile apparatus having a relay function of transferring an image received through facsimile communication to other facsimile apparatus, comprising:
facsimile communication means for conducting facsimile communication in accordance with the ITU recommendation;
address recognition means for recognizing a transfer address based on relay destination information when the relay destination information is added by the same modulation method as that of an image signal after an. RTC signal stipulated as an end signal of the image signal by the ITU recommendation in facsimile communication received by the facsimile communication means;
image storage means for storing an image represented by the image signal of facsimile communication received by the facsimile communication means; and
transfer control means for controlling the facsimile communication means so that the image stored in the image storage means can be transferred by facsimile communication to the transfer address recognized by the address recognition means.

8. The facsimile apparatus of claim 7, wherein the transfer control means controls the facsimile communication means so that the images stored in the image storage means can be transferred to a plurality of relay destinations when the address recognition means recognizes these relay destinations as the transfer address.

9. The facsimile apparatus of claim 7, wherein the facsimile communication means can conduct facsimile communication through a public-switched telephone network and through an information communication network, and the transfer control means controls the facsimile communication means so that facsimile communication through the public-switched telephone network and facsimile communication through the information communication network can be switched on the basis of the format of the transfer address recognized by the address recognition means.

10. The facsimile apparatus of claim 7, wherein the transfer control means groups images of a plurality of pages into a group and controls the facsimile communication means in such a fashion as to transfer the images to the transfer address by facsimile communication when the transfer address recognized by the address recognition means is added after the last image of the images of a plurality of pages.

11. The facsimile apparatus of claim 7, wherein, the address recognition means includes a conversion table between the relay destination information and the transfer address of the relay destination, and converts the relay destination information added to the facsimile communication received by the facsimile communication means to the transfer address by using the conversion table.

12. The facsimile apparatus of claim 7, wherein the transfer control means controls the facsimile communication means so that, when the relay destination information is added to facsimile communication received by the facsimile communication means, the facsimile communication means conducts the transfer operation only when a predetermined condition is satisfied.

13. A program for causing a computer to operate as a facsimile apparatus, comprising the steps of:
waiting an input of relay destination information about a transfer address of a relay destination to relay destination inputting means; and
conducting facsimile communication to a facsimile apparatus having the relay function in accordance with the ITU recommendation and forwarding the relay destination information inputted to relay destination inputting means by the same modulation method as that of the image signal after an RTC signal stipulated as an end signal of an image signal by the ITU recommendation, by facsimile communication means.

14. A program for causing a computer to operate as a facsimile apparatus, comprising the steps of:
storing an image represented by an image signal of facsimile communication received by facsimile communication means for conducting facsimile communication in accordance with the ITU recommendation, in image storage means;
judging whether or not relay destination information is added by the same modulation method as that of an image signal after an RTC signal stipulated as an end signal of the image signal by the ITU recommendation in facsimile communication received by the facsimile communication means;
when it is judged that relay destination information is added, recognizing a transfer address based on the relay destination information by address recognition means; and
transferring the image stored in the image storage means by facsimile communication by means of the facsimile communication means to the transfer address recognized by the address recognition means.

15. The program of claim 14, further comprising:
a step of transferring the images stored in the image storage means to a plurality of relay destinations when the address recognition means recognizes these relay destinations as the transfer address.

16. The program of claim 14, further comprising:
a step of switching facsimile communication through a public-switched telephone network and facsimile communication through an information communication network on the basis of the format of the transfer address recognized by the address recognition means.

17. The program of claim 14, further comprising:
a step of grouping images of a plurality of pages into a group and transferring the images to the transfer address by facsimile communication when the transfer address recognized by the address recognition means is added after the last image of the images of a plurality of pages.

18. The program of claim 14, further comprising:
a step of converting the relay destination information added to the facsimile communication received by the facsimile communication means to the transfer address by using a conversion table between the relay destination information and the transfer address of the relay destination which table is included in the address recognition means.

19. The program of claim 14, further comprising:
a step of, when the relay destination information is added to facsimile communication received by the facsimile communication means, conducting the transfer operation only when a predetermined condition is satisfied.

20. A computer-readable recording medium recording a program for causing a computer to operate as a facsimile apparatus, the program comprising the steps of:
waiting an input of relay destination information about a transfer address of a relay destination to relay destination inputting means; and
conducting facsimile communication to a facsimile apparatus having the relay function in accordance with the ITU recommendation and forwarding the relay destination information inputted to relay destination inputting means by the same modulation method as that of the image signal after an RTC signal stipulated as an end signal of an image signal by the ITU recommendation, by facsimile communication means.

21. A computer-readable recording medium recording a program for causing a computer to operate as a facsimile apparatus, the program comprising the steps of:
storing an image represented by an image signal of facsimile communication received by facsimile communication means for conducting facsimile communication in accordance with the ITU recommendation, in image storage means;
judging whether or not relay destination information is added by the same modulation method as that of an image signal after an RTC signal stipulated as an end signal of the image signal by the ITU recommendation in facsimile communication received by the facsimile communication means;
when it is judged that relay destination information is added, recognizing a transfer address based on the relay destination information by address recognition means; and
transferring the image stored in the image storage means by facsimile communication by means of the facsimile communication means to the transfer address recognized by the address recognition means.

22. The computer-readable recording medium of claim 21, the program further comprising:
a step of transferring the images stored in the image storage means to a plurality of relay destinations when the address recognition means recognizes these relay destinations as the transfer address.

23. The computer-readable recording medium of claim 21, the program further comprising:
a step of switching facsimile communication through a public-switched telephone network and facsimile communication through an information communication network on the basis of the format of the transfer address recognized by the address recognition means.

24. The computer-readable recording medium of claim 21, the program further comprising:
a step of grouping images of a plurality of pages into a group and transferring the images to the transfer address by facsimile communication when the transfer address recognized by the address recognition means is added after the last image of the images of a plurality of pages.

25. The computer-readable recording medium of claim 21, the program further comprising:
a step of converting the relay destination information added to the facsimile communication received by the facsimile communication means to the transfer address by using a conversion table between the relay destination information and the transfer address of the relay destination which table is included in the address recognition means.

26. The computer-readable recording medium of claim 21, the program further comprising:
a step of, when the relay destination information is added to facsimile communication received by the facsimile communication means, conducting the transfer operation only when a predetermined condition is satisfied.
